(19) United States
(12) Patent Application Publication
(10) Pub. No.: US 2013/0275113 A1
(43) Pub. Date: Oct. 17, 2013

(54) AVAILABILITY MODEL GENERATION DEVICE

(71) Applicant: Kumiko Tadano, Tokyo (JP)

(72) Inventor: Kumiko Tadano, Tokyo (JP)

(73) Assignee: NEC CORPORATION, Tokyo (JP)

(21) Appl. No.: 13/882,367

(22) PCT Filed: Jun. 10, 2011
(86) PCT No.: PCT/JP2011/003292

§ 371 Date: May 24, 2013

(30) Foreign Application Priority Data
Oct. 29, 2010 (JP) 2010-242938

(51) Int. Cl. G06F 17/50

(52) U.S. Cl. CPC G06F 17/5009
USPC 703/21

(57) ABSTRACT

The availability model generation device 100 includes an operation procedure information acceptance section 101 which accepts operation procedure information representing an operation procedure including a plurality of manipulations for operating an information processing system and also representing the sequence that the respective manipulations are executed, and an availability model generation section 102 which generates, based on the operation procedure information, an availability model for estimating the availability of the information processing system in a case where the manipulations are executed in accordance with the operation procedure represented by the accepted operation procedure information.

### TECHNICAL FIELD

The present invention relates to an availability model generation device which generates an availability model for estimating availability of an information processing system.

### BACKGROUND ART

Technologies for estimating availability of an information processing system have been known. As one of such technologies, the art described in Patent Document 1 estimates availability of an information processing system based on the configuration of the information processing system and the failure rate and the recovery rate of each computer constituting the information processing system, when the information processing system is in operation.

Meanwhile, the impact of manipulations (for example, an input of information by a user, and the like) for operating the information processing system, on the availability of the information processing system, is relatively large. However, the art described in Patent Document 1 does not consider the impact of manipulations on the availability. On the other hand, the art described in Non-Patent Document 1 constructs a mathematical model corresponding to a particular manipulation, and estimates the availability based on the mathematical model.
Patent Document 1: U.S. Pat. No. 7,756,803 B
Non-Patent Document 1: V. Castelli et al., “Proactive management of software aging”, IBM Journal of Research and Development, IBM, March 2001, Vol. 45, No. 2, pp. 311-332

### SUMMARY

However, as the above-described art uses a mathematical model which is constructed only for a particular manipulation, it is impossible to appropriately evaluate the impact of the operation procedure, consisting of various kinds of manipulations, on the availability. As such, there has been a problem that it is impossible to appropriately generate an availability model for estimating the availability of an information processing system in the case where a plurality of manipulations are performed in accordance with the operation procedure. Accordingly, with the above-described art, it is impossible to specify a manipulation which lowers the availability most, among a plurality of manipulations included in the operation procedure, for example.

As such, an object of the present invention is to provide an availability model generation device capable of solving the above-described problem, that is, “there is a case where it is impossible to appropriately generate an availability model for estimating availability of an information processing system if a plurality of manipulations are performed in accordance with an operation procedure”.

In order to achieve the above-described object, an availability model generation device, which is an aspect of the present invention, includes:

an operation procedure information acceptance means for accepting operation procedure information representing an operation procedure including a plurality of manipulations for operating an information processing system and also representing the content of each of the plurality of the manipulations and the sequence that the respective manipulations are executed; and

an availability model generation means for generating, based on the operation procedure information, an availability model for estimating availability of the information processing system in a case where the plurality of the manipulations are executed in accordance with the operation procedure represented by the accepted operation procedure information.

Further, an availability model generation method, which is another aspect of the present invention, includes:

accepting operation procedure information representing an operation procedure including a plurality of manipulations for operating an information processing system and also representing the content of each of the plurality of the manipulations and the sequence that the respective manipulations are executed; and

generating, based on the operation procedure information, an availability model for estimating availability of the information processing system in a case where the plurality of the manipulations are executed in accordance with the operation procedure represented by the accepted operation procedure information.

Further, an availability model generation program, which is another aspect of the present invention, is a program for causing an information processing device to realize:

an operation procedure information acceptance means for accepting operation procedure information representing an operation procedure including a plurality of manipulations for operating an information processing system and also representing the content of each of the plurality of the manipulations and the sequence that the respective manipulations are executed; and

an availability model generation means for generating, based on the operation procedure information, an availability model for estimating availability of the information processing system in a case where the plurality of the manipulations are executed in accordance with the operation procedure represented by the accepted operation procedure information.

With the above-described configuration, the present invention is able to appropriately generate an availability model for estimating availability of an information processing system in a case where a plurality of manipulations are performed in accordance with an operation procedure.

### BRIEF DESCRIPTION OF DRAWINGS

FIG. 1 is a schematic block diagram showing an availability model generation device according to a first exemplary embodiment of the present invention.

FIG. 2 is a flowchart showing the outline of an operation of the availability model generation device according to the first exemplary embodiment of the present invention.

FIG. 3 is an illustration showing an example of an activity diagram represented by operation procedure information according to the first exemplary embodiment of the present invention.

FIG. 4 is an illustration conceptually showing an activity diagram represented by operation procedure information and an availability model, according to the first exemplary embodiment of the present invention.

FIG. 5 is an illustration conceptually showing the details of a manipulation model according to the first exemplary embodiment of the present invention.

FIG. 6 is a schematic block diagram showing an availability model generation device according to a second exemplary embodiment of the present invention.

FIG. 7 is a schematic block diagram showing an availability model generation device according to a third exemplary embodiment of the present invention.

### EXEMPLARY EMBODIMENTS

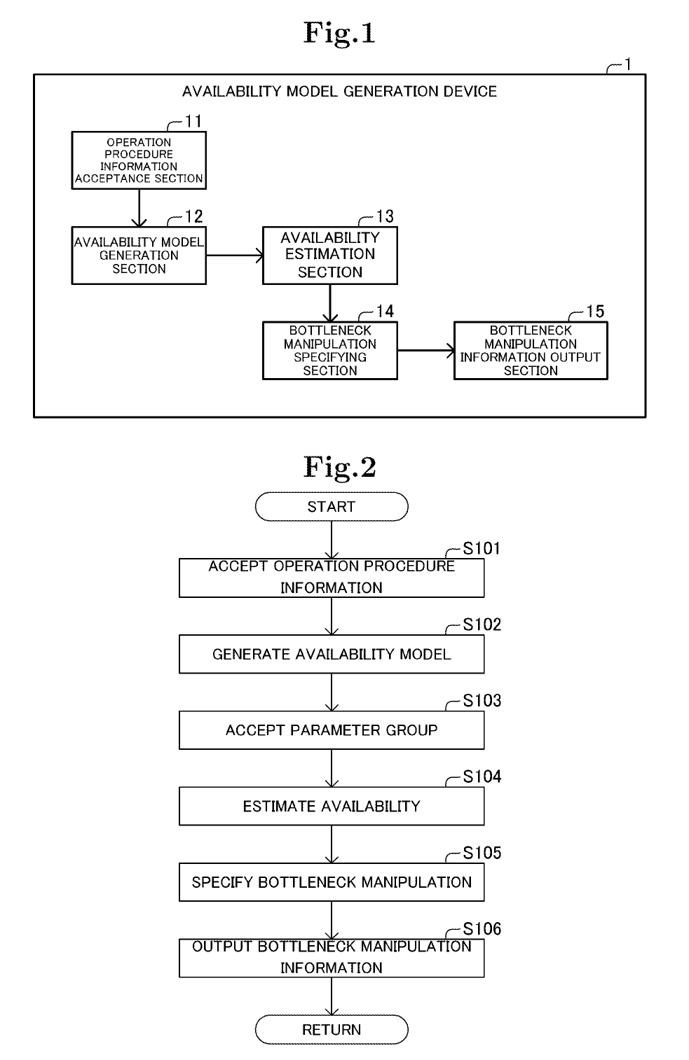

Hereinafter, exemplary embodiments of an availability model generation device, an availability model generation method, and an availability model generation program, according to the present invention, will be described with reference to FIGS. 1 to 7.

### First Exemplary Embodiment

### (Configuration)

As shown in FIG. 1, an availability model generation device 1 according to a first exemplary embodiment is an information processing device. For example, the availability model generation device 1 is a server device, a personal computer, or the like.

The availability model generation device 1 includes a CPU (Central Processing Unit), storing units (memory and HDD (Hard Disk Drive)), and an input device (in this example, keyboard), and an output device (in this example, display). The availability model generation device 1 is adapted to realize the functions described below by a program, stored in a storing unit, executed by the CPU.

### (Function)

FIG. 1 is a block diagram showing the functions of the availability model generation device 1 configured as described above. The functions of availability model generation device 1 include an operation procedure information acceptance section (operation procedure information acceptance means) 11, an availability model generation section (availability model generation means) 12, an availability estimation section (availability estimation means) 13, a bottleneck manipulation specifying section (bottleneck manipulation specifying means) 14, a bottleneck manipulation information output section (bottleneck manipulation information output means) 15.

The operation procedure information acceptance section 11 accepts operation procedure information. The operation procedure information is information representing an operation procedure consisting of a plurality of manipulations for operating an information processing system, not shown, for which availability is estimated, and showing contents of the respective manipulations and the sequence that the respective manipulations are executed. In this example, the operation procedure information is information shown by an activity diagram. In this example, the information processing system is configured of at least one information processing device.

In this example, availability is an operation rate of the information processing system. An operation rate is, for example, an instantaneous operation rate or an average operation rate. An instantaneous operation rate is a probability that the information processing system functions at a particular point of time, and an average operation rate is a probability that the information processing system functions in a predetermined period of time.

In this example, the operation procedure information acceptance section 11 is adapted to accept operation procedure information input by a user. It should be noted that the operation procedure information acceptance section 11 may be adapted to accept operation procedure information by receiving operation procedure information from another device.

The availability model generation section 12 generates an availability model for estimating availability of the information processing system in a case where a plurality of manipulations are performed in accordance with the operation procedure represented by the operation procedure information accepted by the operation procedure information acceptance section 11, based on the operation procedure information.

In this example, the availability model is a model representing a relationship between a parameter group consisting of parameters representing changes in the state of the information processing system along with execution of the manipulations with respect to the respective manipulations represented by the operation procedure information accepted by the operation procedure information acceptance section 11, and the availability of the information processing system. Further, in this example, the availability model is a model using probability distribution (e.g., model using Stochastic Reward Nets (SRN).

In this example, a parameter is an average execution time which is an average value of a period of time required for executing a manipulation, a success probability which is a probability that execution of a manipulation succeeds, an average transition time which is an average value of a period of time required for transition of the state of the information processing system to the next state when execution of a manipulation is failed, or the like.

The availability estimation section 13 acquires a plurality of different parameter groups. In this example, the availability estimation section 13 is adapted to accept a plurality of parameter groups input by a user to thereby acquire the parameter groups. It should be noted that the availability estimation section 13 may be adapted to acquire a plurality of parameter groups by generating them.

The availability estimation section 13 estimates, with respect to each of the acquired parameter groups, the availability of the information processing system based on the parameter groups and the availability model generated by the availability model generation section 12.

The bottleneck manipulation specifying section 14 specifies a bottleneck manipulation from among a plurality of manipulations represented by the operation procedure information accepted by the operation procedure information acceptance section 11, based on the relationship between the availability estimated by the availability estimation section 13 and the parameter group based on which the availability is estimated. Here, a bottleneck manipulation is a manipulation which lowers the availability most.

The bottleneck manipulation information output section 15 outputs bottleneck manipulation information representing the bottleneck operation specified by the bottleneck manipulation specifying section 14 (in this example, allows bottleneck manipulation information to be shown on the display).

### (Operation)

Next, operation of the availability model generation device 1, described above, will be given.

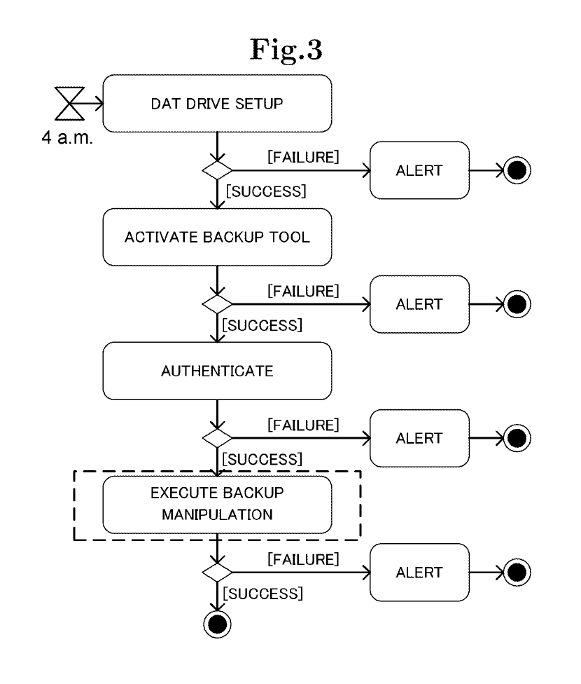

First, the availability model generation device 1 accepts operation procedure information (step S101 in FIG. 2). In this example, operation procedure information is information representing an activity diagram based on SysML (Systems Modeling Language) described in accordance with XMI (Extensible Markup Language Metadata Interchange) format. FIG. 3 shows an exemplary activity diagram represented by the operation procedure information.

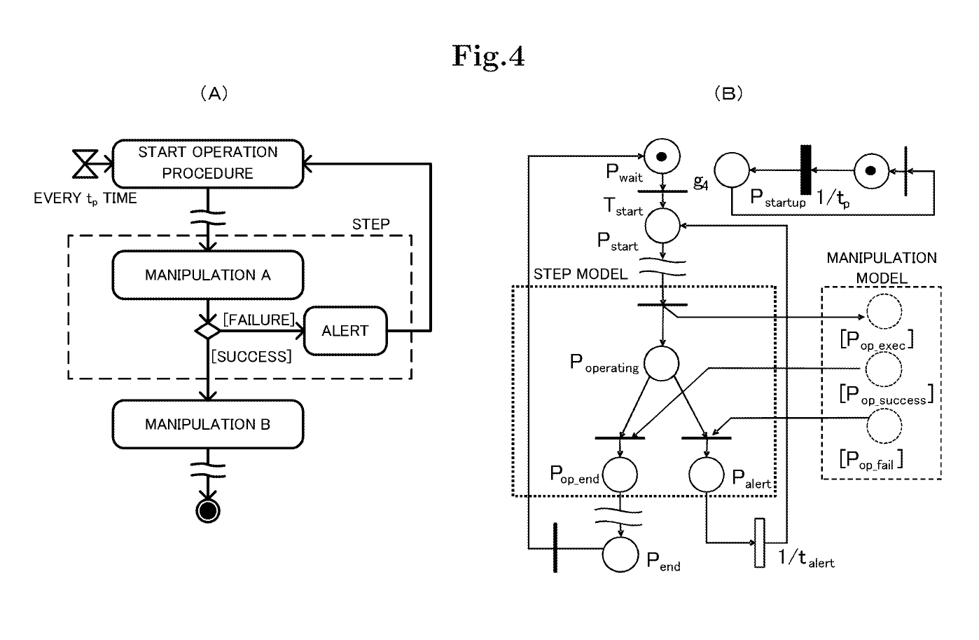

Next, the availability model generation device 1 generates an availability model based on the accepted operation procedure information (step S102 in FIG. 2). In FIG. 4, (A) is an activity diagram showing operation procedure information, and (B) is a diagram showing an availability model using SRN, generated based on the operation procedure information.

In this example, the initial position of a token is a place P_{wait} as shown in FIG. 4. Here, a token represents a state of the information processing system. Further, the operation procedure information shown in (A) of FIG. 4 shows that the operation procedures including a manipulation A and a manipulation B is executed each time a predetermined time period tₚ elapses.

As such, if the token is at a place Pₛₜₐᵣₜᵤₚ (that is, the state of the information processing system is in a state corresponding to the place Pₛₜₐᵣₜᵤₚ), a guard function g₄ causes a transition Tₛₜₐᵣₜ to be able to fire. It should be noted that “transition fires” corresponds to “the state of the information processing system transits (is changed) to the next state”, for example. The guard function causes the transition to be able to fire when the conditions shown by the guard function are satisfied.

Here, a part including one activity, one transition, and one decision (a part surrounded by a dashed line), of the activity diagram shown in (A) of FIG. 4, is called a step.

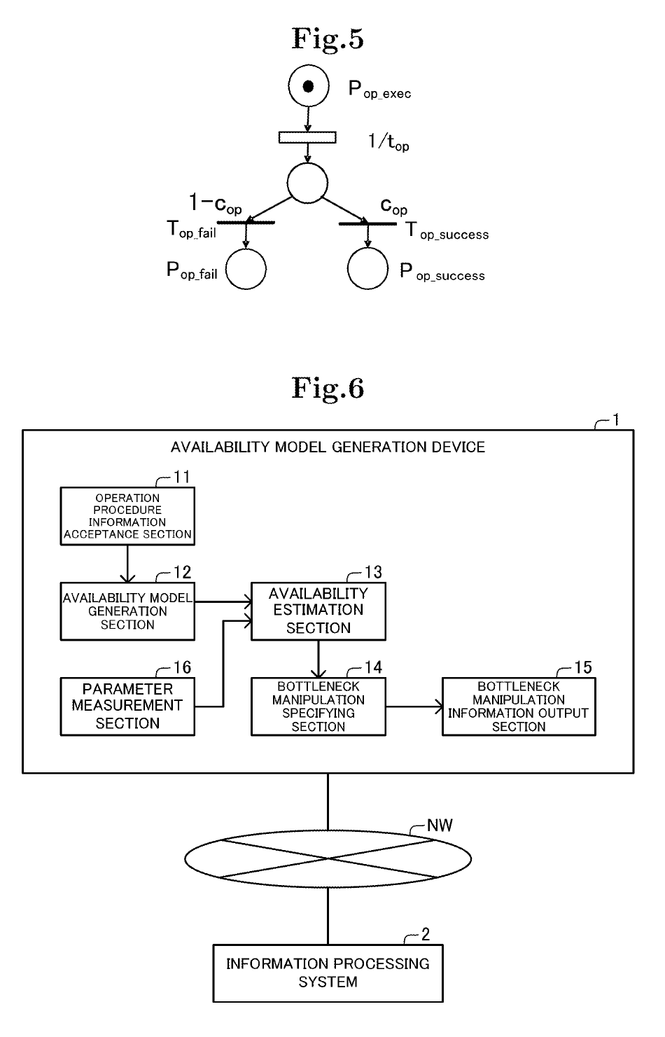

The availability model generation device 1 transforms each step in the activity diagram into a step model and a manipulation model (a part surrounded by a dashed line in (B) of FIG. 4) which is shown with use of SRN. FIG. 5 shows the details of the manipulation model shown in (B) of FIG. 4. As such, a place Pₒₚ_{_{—}}_{exec}, a place Pₒₚ_{_{—}}_{success}, and a place Pₒₚ_{_{—}}_{fail}, shown in (B) of FIG. 4 and FIG. 5, respectively represent the same place.

The availability model generation device 1 generates an availability model by connecting a step model with each step of the activity diagram in association with each other.

In order to simplify the description, this example assumes an example that if execution of a manipulation failed (if a token is at a place Pₐₗₑᵣₜ), the token returns to the place Pₛₜₐᵣₜ which is the first place in the operation procedure after the average transition time tₐₗₑᵣₜ has elapsed. Here, an average transition time is an average value of a period of time required for transition of the state of the information processing system to the next state when execution of the manipulation failed. Further, this example also assumes an example that the token returns to the initial place P_{wait} if all manipulations constituting the operation procedure succeeded.

A step model is an SRN module representing execution of one manipulation and the result thereof (execution result). Here, P_{operating} is a place representing the state of the information processing system when a manipulation is being executed, Pₒₚ_{_{—}}_{end} is a place representing the state of the information processing system when the execution of a manipulation succeeded, and Pₐₗₑᵣₜ is a place representing the state of the information processing system when execution of a manipulation failed.

Further, the token transits to, subsequent to the place Pₒₚ_{_{—}}_{end} which is the place of the i^{th} manipulation, transition immediately before the place P_{operating} which is the place of the i+1^{th} manipulation (transition above the place P_{operating} shown in (B) of FIG. 4).

Further, changes in the state of the information processing system, caused along with execution of manipulations, are shown by the manipulation model shown in FIG. 5. Here, Pₒₚ_{_{—}}_{exec} is a place representing the state of the information processing system when manipulation is being executed, Pₒₚ_{_{—}}_{success} is a place representing the state of the information processing system when a manipulation succeeded, and Pₒₚ_{_{—}}_{fail} is a place representing the state of the information processing system when a manipulation failed.

Further, Tₒₚ_{_{—}}_{fail} is a transition which fires when execution of a manipulation failed, and Tₒₚ_{_{—}}_{success} is a transition which fires when execution of manipulation succeeded.

Further, tₒₚ is an average value of a period of time required for executing a manipulation (average execution time), and cₒₚ is a probability that execution of a manipulation succeeds (success probability). Accordingly, as described above, a probability that the transition Tₒₚ_{_{—}}_{success} fires is a success probability cₒₚ, while a probability that the transition Tₒₚ_{_{—}}_{fail} fires is a failure probability 1-cₒₚ.

It should be noted that each of the average execution time tₒₚ and the success probability cₒₚ may take a different value for each manipulation.

In this way, changes in the state of the information processing system in the operation model correspond to success or failure of execution of a manipulation.

Next, the availability model generation device 1 accepts a plurality of different parameter groups (step S103 in FIG. 2). In this example, a parameter group includes, with respect to each manipulation, an average execution time tₒₚ, a success probability cₒₚ, and an average transition time tₐₗₑᵣₜ. It should be noted that in this example, a plurality of parameter groups consist of values input by a user.

Then, with respect to each of the accepted parameter groups, the availability model generation device 1 estimates (calculates) the availability of the information processing system (in this example, operation rate) based on the parameter group and the generated availability model (step S104 in FIG. 2).

In this example, the availability model generation device 1 estimates the availability using well-known art such as SHARPE (Symbolic Hierarchical Automated Reliability and Performance Evaluator) or SPNP (Stochastic Petri Net Package).

Then, based on the relationship between the availability estimated for each of the parameter groups and the parameter group based on which the availability is estimated, the availability model generation device 1 estimates a bottleneck manipulation from among a plurality of manipulations represented by the accepted operation procedure information (step S105 in FIG. 2). Here, the bottleneck manipulation is a manipulation which lowers the availability most.

In this example, the availability model generation device 1 assumes that when the token is at the place Pₐₗₑᵣₜ, the state of the information processing system is not in operation (system down), while when the token is not at the place Pₐₗₑᵣₜ, the state of the information processing system is in operation. In this case, the availability model generation device 1 is able to specify a bottleneck manipulation using a reward function.

For example, as a reward function, the availability model generation device 1 uses a function which outputs “0” when the token is at the place Pₐₗₑᵣₜ, and outputs “1” when the token is at a place other than the place Pₐₗₑᵣₜ. In this case, the availability model generation device 1 calculates a time average value of the output value of the reward function as an average operation rate. Then, the availability model generation device 1 specifies the bottleneck manipulation based on the calculated average operation rate.

Further, the availability model generation device 1 may set the value of the success probability cₒₚ, with respect to a manipulation, to be “1” to thereby eliminate the impact of the manipulation on the availability of the information processing system, for example. Accordingly, as a plurality of parameter groups, a user inputs parameter groups, in which the value of the success probability cₒₚ with respect to one manipulation probability is “1”, of the number corresponding to the number of manipulations included in the operation procedure. Then, the availability model generation device 1 specifies a manipulation which improves the availability most when the impact thereof on the availability of the information processing system is eliminated, as a bottleneck manipulation.

Then, the availability model generation device 1 outputs bottleneck manipulation information representing the specified bottleneck manipulation (in this example, allows the bottleneck manipulation information to be shown on the display) (step S106 in FIG. 2). For example, the availability model generation device 1 outputs bottleneck manipulation information by causing an image, in which the bottleneck manipulation is surrounded by the dashed line in the activity diagram, to be shown on the display, as shown in FIG. 3.

According to this configuration, it is possible to allow the user to easily recognize the bottleneck manipulation. As such, the convenience of the user can be improved.

As described above, according to the availability model generation device 1 of the first exemplary embodiment of the present invention, it is possible to appropriately generate an availability model for estimating the availability of the information processing system in the case where a plurality of manipulations are executed in accordance with the operation procedure. Further, according to the availability model generation device 1, it is possible to specify the bottleneck manipulation. Consequently, the availability of the information processing system can be improved easily.

It should be noted that the availability model generation device 1 may be configured to output a list of manipulations included in the operation procedure in a state where they are arranged in order of reducing the availability. In that case, the availability model generation device 1 may be configured to output the value of availability which is changed depending on presence or absence of a manipulation, in association with the manipulation.

With this configuration, even if it is difficult to improve the availability by adjusting the bottleneck operation, it is possible to easily improve the availability by adjusting another manipulation in which the impact on the availability is relatively large.

Further, the availability model generation device 1 may be configured to calculate availability with respect to a parameter group (for example, a parameter group reflecting the state of the information processing system in operation) and output the calculated availability, without specifying a bottleneck manipulation.

It should be noted that the availability model generation device 1 may be configured of a plurality of information processing devices.

### Second Exemplary Embodiment

Next, an availability model generation device according to a second exemplary embodiment of the present invention will be described. The availability model generation device of the second exemplary embodiment is different from the availability model generation device of the first exemplary embodiment in that availability is estimated based on a parameter measured during operation of the information processing system. Accordingly, description will be given below focusing on such a difference.

As shown in FIG. 6, the availability model generation device 1 according to the second exemplary embodiment is communicably connected with an information processing system 2 over a communication network NW.

Further, the functions of the availability model generation device 1 of the second exemplary embodiment includes a parameter measurement section (parameter measurement means) 16, in addition to the functions of the availability model generation device 1 of the first exemplary embodiment.

The parameter measurement section 16 measures a parameter during operation of the information processing system 2. In this example, a parameter measured by the parameter measurement section 16 is a success probability. For example, the parameter measurement section 16 measures a success probability by, when a command instructing execution of a manipulation is input, determining whether or not a return value in response to the command matches a predetermined value.

The availability estimation section 13 accepts the parameter measured by the parameter measurement section 16. In this example, the availability estimation section 13 accepts parameters (in this example, average transition time and average execution time) other than the accepted parameter, among a parameter group, by an input from a user. The availability estimation section 13 acquires a parameter group including the parameter measured by the parameter measurement section 16 and the accepted parameters.

Then, similar to the availability estimation section 13 of the first exemplary embodiment, the availability estimation section 13 estimates, for each of the acquired parameter groups, availability of the information processing system based on the parameter group and the availability model generated by the availability model generation section 12.

As described above, according to the availability model generation device 1 of the second exemplary embodiment of the present invention, same actions and advantageous effects as those of the availability model generation device 1 of the first exemplary embodiment can be achieved.

Further, according to the availability model generation device 1 of the second exemplary embodiment, as the availability is estimated based on the parameters which have been actually measured, availability of the information processing system can be estimated with higher accuracy. Further, compared with the case where all parameters are input by a user, it is possible to save time and effort to input parameters by a user, and also possible to prevent erroneous input of parameters by a user.

It should be noted that the availability model generation device 1 may be configured of a plurality of information processing devices. For example, the availability model generation device 1 may be configured of a first information processing device including the operation procedure information acceptance section 11 to the bottleneck manipulation information output section 15, and a second information processing device including the parameter measurement section 16.

### Third Exemplary Embodiment

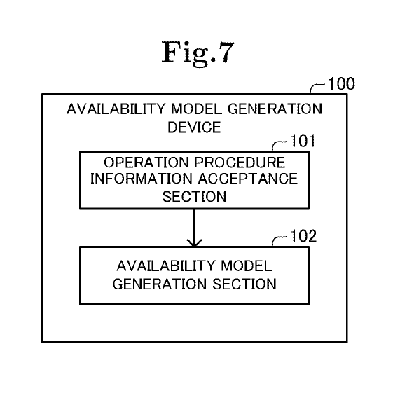

Next, an availability model generation device according to a third exemplary embodiment of the present invention will be described with reference to FIG. 7.

An availability model generation device 100 according to the third exemplary embodiment includes

an operation procedure information acceptance section (operation procedure information acceptance means) 101 which accepts operation procedure information representing an operation procedure consisting of a plurality of manipulations for operating an information processing system and also representing the sequence that the respective manipulations are executed, and

an availability model generation section (availability model generation means) 102 which generates, based on the operation procedure information, an availability model for estimating availability of the information processing system in a case where the manipulations are executed in accordance with the operation procedure represented by the accepted operation procedure information.

With this configuration, it is possible to appropriately generate an availability model for estimating availability of the information processing system when manipulations are executed in accordance with the operation procedure.

While the present invention has been described with reference to the exemplary embodiments described above, the present invention is not limited to the above-described embodiments. The form and details of the present invention can be changed within the scope of the present invention in various manners that can be understood by those skilled in the art.

It should be noted that in each of the exemplary embodiments, while the respective functions of the availability model generation device 1 are realized by a program (software) which is executed by a CPU, they may be realized by hardware such as circuits.

Further, while the program is stored in a storing unit in each of the exemplary embodiments, it may be stored on a computer-readable recording medium. For example, a recording medium is a portable medium such as a flexible disk, an optical disk, a magneto-optical disk, a semiconductor memory, or the like.

Further, as another variation of the above-described exemplary embodiments, any combination of any of the above-described embodiments and variations may be adopted.

### <Supplementary Note>

The whole or part of the exemplary embodiments disclosed above can be described as, but not limited to, the following supplementary notes.

### (Supplementary Note 1)

An availability model generation device comprising:

operation procedure information acceptance means for accepting operation procedure information representing an operation procedure including a plurality of manipulations for operating an information processing system and also representing a content of each of the plurality of the manipulations and a sequence that the respective manipulations are executed; and

availability model generation means for generating, based on the operation procedure information, an availability model for estimating availability of the information processing system in a case where the plurality of the manipulations are executed in accordance with the operation procedure represented by the accepted operation procedure information.

With this configuration, it is possible to appropriately generate an availability model for estimating the availability of the information processing system in a case where the manipulations are executed in accordance with the operation procedure.

### (Supplementary Note 2)

The availability model generation device, according to claim 1, wherein

the availability model is a model representing, with respect to each of the plurality of the manipulations represented by the accepted operation procedure information, a relationship between a parameter group including parameters representing a change in a state of the information processing system along with execution of the manipulation, and the availability of the information processing system, and

the availability model generation device further comprises

availability estimation means for estimating the availability with respect to each of the parameter groups which are different from each other, based on the parameter group and the generated availability model, and

bottleneck manipulation specifying means for specifying, from among the plurality of the manipulations, a bottleneck manipulation which lowers the availability most, based on a relationship between the estimated availability and the parameter group based on which the availability is estimated.

With this configuration, a bottleneck manipulation can be specified.

### (Supplementary Note 3)

The availability model generation device, according to claim 2, further comprising

bottleneck manipulation information output means for outputting bottleneck manipulation information representing the specified bottleneck manipulation.

With this configuration, it is possible to easily allow a user to recognize the bottleneck manipulation. As such, user-friendliness can be improved.

### (Supplementary Note 4)

The availability model generation device, according to claim 2 or 3, further comprising

parameter measurement means for measuring the parameter during operation of the information processing system, wherein

the availability estimation means is adapted to estimate the availability based on the measured parameter.

With this configuration, availability of the information processing system can be estimated with higher accuracy.

### (Supplementary Note 5)

The availability model generation device, according to any of claims 1 to 4, wherein

the parameter is an average execution time which is an average value of a period of time required to execute the manipulation, a success probability which is a probability that the manipulation succeeds, or an average transition time which is an average value of a period of time required for transition of a state of the information processing system to the next state if execution of the manipulation fails.

### (Supplementary Note 6)

The availability model generation device, according to any of claims 1 to 5, wherein

the operation procedure information is information representing an activity diagram.

### (Supplementary Note 7)

The availability model generation device, according to any of claims 1 to 6, wherein

the availability model is a model using probability distribution.

### (Supplementary Note 8)

An availability model generation method comprising:

accepting operation procedure information representing an operation procedure including a plurality of manipulations for operating an information processing system and also representing a content of each of the plurality of the manipulations and a sequence that the respective manipulations are executed; and

generating, based on the operation procedure information, an availability model for estimating availability of the information processing system in a case where the plurality of the manipulations are executed in accordance with the operation procedure represented by the accepted operation procedure information.

### (Supplementary Note 9)

The availability model generation method, according to claim 8, wherein

the availability model is a model representing, with respect to each of the plurality of the manipulations represented by the accepted operation procedure information, a relationship between a parameter group including parameters representing a change in a state of the information processing system along with execution of the manipulation, and the availability of the information processing system, and

the availability model generation method further comprises

estimating the availability with respect to each of the parameter groups which are different from each other, based on the parameter group and the generated availability model, and

specifying, from among the plurality of the manipulations, a bottleneck manipulation which lowers the availability most, based on a relationship between the estimated availability and the parameter group based on which the availability is estimated.

### (Supplementary Note 10)

An availability model generation program for causing an information processing device to realize:

operation procedure information acceptance means for accepting operation procedure information representing an operation procedure including a plurality of manipulations for operating an information processing system and also representing a content of each of the plurality of the manipulations and a sequence that the respective manipulations are executed; and

availability model generation means for generating, based on the operation procedure information, an availability model for estimating availability of the information processing system in a case where the plurality of the manipulations are executed in accordance with the operation procedure represented by the accepted operation procedure information.

### (Supplementary Note 11)

The availability model generation program, according to claim 10, wherein

the availability model is a model representing, with respect to each of the plurality of the manipulations represented by the accepted operation procedure information, a relationship between a parameter group including parameters representing a change in a state of the information processing system along with execution of the manipulation, and the availability of the information processing system, and

the program further causes the availability model generation device to realize
availability estimation means for estimating the availability with respect to each of the parameter groups which are different from each other, based on the parameter group and the generated availability model, and
bottleneck manipulation specifying means for specifying, from among the plurality of the manipulations, a bottleneck manipulation which lowers the availability most, based on a relationship between the estimated availability and the parameter group based on which the availability is estimated.

The present invention is based upon and claims the benefit of priority from Japanese patent application No. 2010-242938, filed on Oct. 29, 2010, the disclosure of which is incorporated herein in its entirety by reference.

### INDUSTRIAL APPLICABILITY

The present invention is applicable to an availability model generation device which generates an availability model for estimating availability of an information processing system, for example.

### DESCRIPTION OF REFERENCE NUMERALS

1 availability model generation device
2 information processing system
11 operation procedure information acceptance section
12 availability model generation section
13 availability estimation section
14 bottleneck manipulation specifying section
15 bottleneck manipulation information output section
16 parameter measurement section
100 availability model generation device
101 operation procedure information acceptance section
102 availability model generation section
NW communication network

1. An availability model generation device comprising:
an operation procedure information acceptance unit that accepts operation procedure information representing an operation procedure including a plurality of manipulations for operating an information processing system and also representing a content of each of the plurality of the manipulations and a sequence that the respective manipulations are executed; and
an availability model generation unit that generates, based on the operation procedure information, an availability model for estimating availability of the information processing system in a case where the plurality of the manipulations are executed in accordance with the operation procedure represented by the accepted operation procedure information.

2. The availability model generation device, according to claim 1, wherein
the availability model is a model representing, with respect to each of the plurality of the manipulations represented by the accepted operation procedure information, a relationship between a parameter group including parameters representing a change in a state of the information processing system along with execution of the manipulation, and the availability of the information processing system, and
the availability model generation device further comprises
an availability estimation unit that estimates the availability with respect to each of the parameter groups which are different from each other, based on the parameter group and the generated availability model, and
a bottleneck manipulation specifying unit that specifies, from among the plurality of the manipulations, a bottleneck manipulation which lowers the availability most, based on a relationship between the estimated availability and the parameter group based on which the availability is estimated.

3. The availability model generation device, according to claim 2, further comprising
a bottleneck manipulation information output unit that outputs bottleneck manipulation information representing the specified bottleneck manipulation.

4. The availability model generation device, according to claim 2, further comprising
a parameter measurement unit that measures the parameter during operation of the information processing system, wherein
the availability estimation unit is adapted to estimate the availability based on the measured parameter.

5. The availability model generation device, according to claim 1, wherein
the parameter is an average execution time which is an average value of a period of time required to execute the manipulation, a success probability which is a probability that the manipulation succeeds, or an average transition time which is an average value of a period of time required for transition of a state of the information processing system to the next state if execution of the manipulation fails.

6. The availability model generation device, according to claim 1, wherein
the operation procedure information is information representing an activity diagram.

7. The availability model generation device, according to claim 1, wherein
the availability model is a model using probability distribution.

8. An availability model generation method comprising:
accepting operation procedure information representing an operation procedure including a plurality of manipulations for operating an information processing system and also representing a content of each of the plurality of the manipulations and a sequence that the respective manipulations are executed; and
generating, based on the operation procedure information, an availability model for estimating availability of the information processing system in a case where the plurality of the manipulations are executed in accordance with the operation procedure represented by the accepted operation procedure information.

9. The availability model generation method, according to claim 8, wherein
the availability model is a model representing, with respect to each of the plurality of the manipulations represented by the accepted operation procedure information, a relationship between a parameter group including parameters representing a change in a state of the information processing system along with execution of the manipulation, and the availability of the information processing system, and
the availability model generation method further comprises
estimating the availability with respect to each of the parameter groups which are different from each other, based on the parameter group and the generated availability model, and
specifying, from among the plurality of the manipulations, a bottleneck manipulation which lowers the availability most, based on a relationship between the estimated availability and the parameter group based on which the availability is estimated.

10. A non-transitory computer-readable medium storing an availability model generation program comprising instructions for causing an information processing device to realize:
an operation procedure information acceptance unit that accepts operation procedure information representing an operation procedure including a plurality of manipulations for operating an information processing system and also representing a content of each of the plurality of the manipulations and a sequence that the respective manipulations are executed; and
an availability model generation unit that generates, based on the operation procedure information, an availability model for estimating availability of the information processing system in a case where the plurality of the manipulations are executed in accordance with the operation procedure represented by the accepted operation procedure information.

11. The availability model generation device, according to claim 3, further comprising
a parameter measurement unit that measures the parameter during operation of the information processing system, wherein
the availability estimation unit is adapted to estimate the availability based on the measured parameter.

12. The availability model generation device, according to claim 2, wherein
the parameter is an average execution time which is an average value of a period of time required to execute the manipulation, a success probability which is a probability that the manipulation succeeds, or an average transition time which is an average value of a period of time required for transition of a state of the information processing system to the next state if execution of the manipulation fails.

13. The availability model generation device, according to claim 3, wherein
the parameter is an average execution time which is an average value of a period of time required to execute the manipulation, a success probability which is a probability that the manipulation succeeds, or an average transition time which is an average value of a period of time required for transition of a state of the information processing system to the next state if execution of the manipulation fails.

14. The availability model generation device, according to claim 4, wherein
the parameter is an average execution time which is an average value of a period of time required to execute the manipulation, a success probability which is a probability that the manipulation succeeds, or an average transition time which is an average value of a period of time required for transition of a state of the information processing system to the next state if execution of the manipulation fails.

15. The availability model generation device, according to claim 2, wherein
the operation procedure information is information representing an activity diagram.

16. The availability model generation device, according to claim 3, wherein
the operation procedure information is information representing an activity diagram.

17. The availability model generation device, according to claim 4, wherein
the operation procedure information is information representing an activity diagram.

18. The availability model generation device, according to claim 5, wherein
the operation procedure information is information representing an activity diagram.

19. The availability model generation device, according to claim 2, wherein
the availability model is a model using probability distribution.

20. The availability model generation device, according to claim 3, wherein
the availability model is a model using probability distribution.
